(19) United States
(12) Patent Application Publication
(10) Pub. No.: US 2007/0028491 A1
(43) Pub. Date: Feb. 8, 2007

(54) System to code and identify beverage containers

(76) Inventor: Michael J. Panella, Alexandria, NJ (US)

Correspondence Address: HOFFMANN & BARON, LLP, 6900 JERICHO TURNPIKE, SYOSSET, NY, 11791, US

(21) Appl. No.: 11/253,308

(22) Filed: Oct. 19, 2005

Related U.S. Application Data
(60) Provisional application No. 60/698,682, filed on Jul. 13, 2005.

(51) Int. Cl. G09F 3/00

(52) U.S. Cl. 40/324

(57) ABSTRACT

The present invention is directed to a coding and personalization device for containers to allow an individual to identify the ownership of the container. The coding and personalization device includes an opaque covering over each individual indicia on a portion of the container. The opaque layer is removable or detachable to expose select indicia thereunder to provide customization of that container. Further, a method providing a customization, including removing a portion of the opaque cover on the container to visually distinguish the container from similar looking containers.

### CROSS-REFERENCE TO RELATED APPLICATIONS

This application claims priority to U.S. Provisional Application No. 60/698,682, filed Jul. 13, 2005.

### FIELD OF THE INVENTION

The present invention relates to coding and personalizing containers. More specifically, the present invention relates to a method and apparatus for personalizing a beverage container, to facilitate identification of the container against containers of like appearance.

### BACKGROUND OF THE INVENTION

The proliferation of bottled water, soda, juice and tea in disposable containers has reached epidemic proportions. It is common practice to have a water or beverage container within ones immediate grasp when traveling, at social functions, exercising and in the workplace. Beverages are often purchased and distributed in identically labeled disposable containers, such as Poland® Spring water, Snapple® ice tea, Pepsi® and Coke®. Therefore, when two or more individuals place similarly looking containers in close proximity of each other and later return to retrieve their container, it is difficult to determine which container belongs to them. Often the individual retrieves the wrong container which results in the transmission of germs from making oral contact with another person's beverage container.

Typically, one will try to distinguish their item by marking the container or destroying the label or container. Often one partially or completely removes a label or a tab on a can to distinguish it from others. However, destruction of a container compromises the integrity of the container and creates a hazardous condition, such as sharp edges, which may lead to injury. Additionally, these methods of distinguishing one's container are limited in nature and do not provide convenient customization by the end user. Therefore, there is a need to provide a convenient and safe way to customize an item as well as offering a multitude of distinguishing options.

### SUMMARY OF THE INVENTION

The present invention is directed to an identification mechanism for a container including a container having distinct indicia thereon; and individual covers over each of the distinct indicia, at least one of the covers is selectively removable to reveal at least one of the indicia thereunder to provide visual personalization of the container.

Another embodiment of the present invention is an identification mechanism for a container including a container and an opaque layer. The container has an outer surface with individual indicia thereon. The opaque layer is attached to the outer surface. The opaque layer includes individually removable tabs therein. Each tab covers one of the individual indicia, and the tabs are selectively removable to reveal selected individual indicia thereunder to provide visual identification of the container.

A further embodiment includes an identification mechanism including a preprinted label having individual indicia printed thereon and perforated tabs therein. Each of the perforated tabs corresponds to specific individual indicia. Individually selected perforated tabs corresponding to the specific indicia are removable from the pre-printed label to provide a customization of the label.

Further, the present invention is directed to an identification mechanism for container including a container having an outer surface, an identification layer attached to the outer surface of the container, and an opaque layer being attached to the identification layer. The opaque layer includes removably attached tabs to reveal a portion of the identification layer thereunder.

A further embodiment of the present invention includes an identification mechanism for container including a container having an outer surface, and an opaque layer being attached to the outer surface. The opaque layer includes perforated tabs therein to reveal a portion of the identification layer thereunder upon removal of the perforated tabs.

Furthermore, the present invention is directed to a method for identifying a container including the steps of providing a container having an outer surface; providing an opaque layer having perforated portions therein defining a tab; attaching said opaque layer to the outer surface; and removing select tabs to expose a portion of the outer surface thereunder to personalize the container.

### BRIEF DESCRIPTION OF THE DRAWINGS

FIG. 1 is a side perspective view of a container having a label of the present invention including removable perforated tabs.

FIG. 2 is a side perspective view of a container having a label of the present invention including removable stickers.

FIG. 3 is a side perspective view of a container having a label of the present invention including a scratch off portion.

FIG. 4 is a side perspective view of a container having a label of the present invention including a scratch off portion.

FIG. 5 is a side perspective view of a container having a label of the present invention including a scratch off portion.

FIG. 6 is a side perspective view of a container having a label of the present invention including a designated blank area.

FIG. 7 is a front perspective view of a label of the present invention including removable perforation tabs thereon.

### DETAILED DESCRIPTION OF THE PREFERRED EMBODIMENTS

The present invention is a method and apparatus for coding and personalizing containers by providing each container with an identification mechanism. For example, the identification mechanism includes, but is not limited to, letters, numbers, symbols, shapes, patterns, names and/or colors. These identification mechanisms can be incorporated anywhere on the container's cap, label, underside and/or body surface. A container, as defined herein, refers to any object that can be used to hold a substance. A container herein refers to disposable items, non-disposable items, cans, bottles, cups, bowls, and various food storage devices, etc.

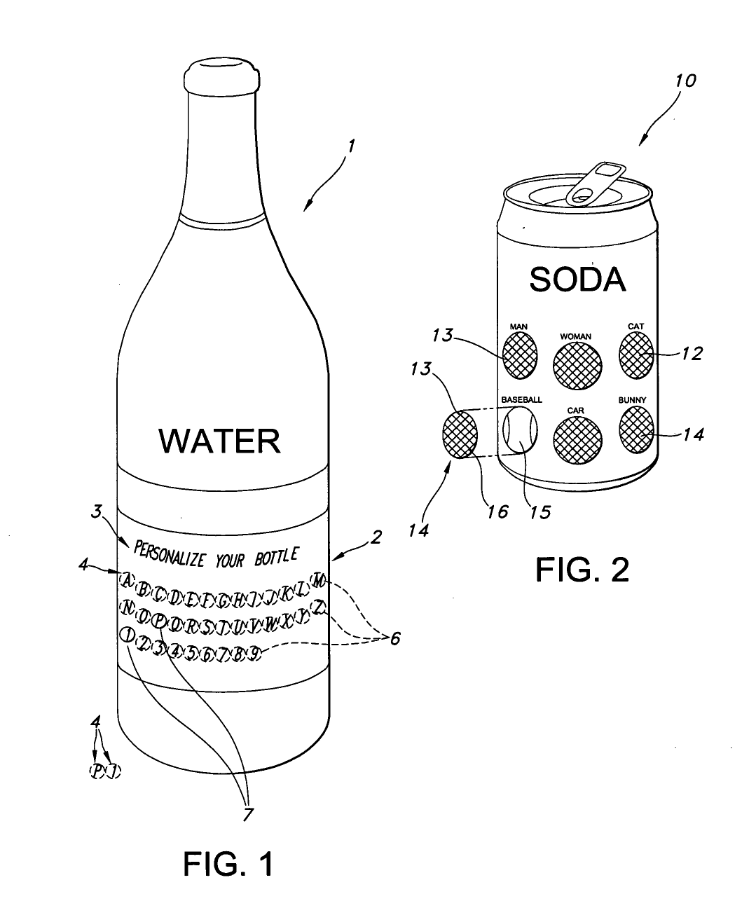

FIGS. 1, 2 and 7 show an identification mechanism 2, 12 and 62, respectively, of the present invention. The identification mechanisms of FIGS. 1, 2 and 7 allows the user to peal off a desired code for personalization of that label and any item of which that label is placed on. More specifically, FIG. 1 shows container 1, as a bottle, including an identification mechanism 2 of the present invention. The identification mechanism 2 includes an opaque layer 3 covering an identification layer 5, or indicia. The opaque layer 3 may have printed information, letters, numbers, etc. thereon. The opaque layer may be a new separate label or incorporated as part of an existing label. The existing label can be modified to include the identification indicia and an identification layer. The opaque layer 3 includes various perforated removable tabs 4. The tabs 4 are removable to reveal a portion of the identification layer 5 thereunder. Either the identification layer 5 as defined herein refers to the outer surface of the container or a separate layer of material sandwiched between the container's outer surface and removable tabs 4. Further, the identification layer 5 may include printed material thereon or remain without printed material. For example, FIG. 1 shows the opaque layer 3 having letters and numbers printed thereon which correspond to the letters and number printed 7 on the identification layer 5. Some tabs 4 are removed to reveal “1” and “P” on the identification layer 5. Upon removal of the tabs 4, the container 1 is personalized and identifiable to that user. When removed by the user pre-selected numbers, letters 4, symbols, names, colors or shapes are revealed, and cannot be replaced.

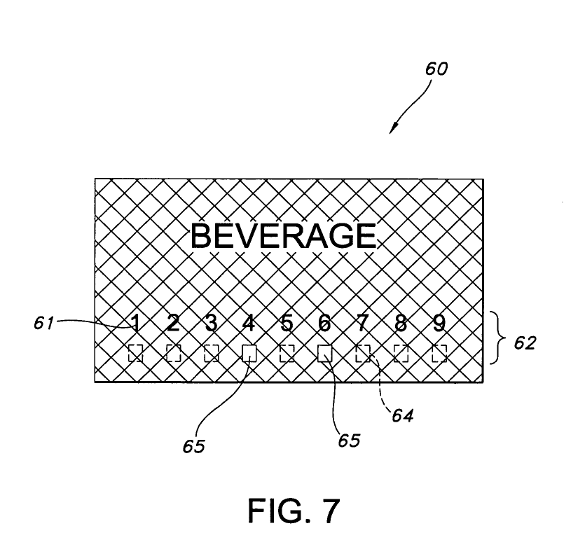

Another embodiment as shown in FIG. 7 is similar to FIG. 1 including an identification mechanism 62. The indication mechanism 62 includes a preprinted label 60 with identification indicia 61 thereon and corresponding perforated removable tabs 64. The identification indicia 61 may include symbols, numbers, letters, markings, etc. The corresponding perforated removable tabs 64 are located on the preprinted label 60 in proximity to the identification indicia 61 for easy association therewith. Further, the identification mechanism 62 may be incorporated into a pre-existing label. In use, the user removes the perforated removable tabs 64, which correspond to the users chosen identification indicia 61 for personalization. Upon removal of the perforated removable tabs 64, the surface of the container is revealed which creates a void in the label, exposing the surface under the label 65, in proximity to the chosen identification indicia 61. This provides a customized label for that user.

A further embodiment as shown in FIG. 2 is similar to the identification mechanism 2 of FIG. 1. The identification mechanism 12 of FIG. 2 is shown on a container 10. The identification mechanism 12 includes an opaque layer 13 and identification layer 15. The opaque layer 13 includes the tabs 14 that are removable to reveal a portion of the identification layer 15 there beneath. The opaque layer 13 further includes an adhesive layer 16 that removably attaches tab 14 of the opaque layer 13 to the identification layer 15, or indicia. Either the identification layer 15 as defined herein refers to the outer surface of the container or a separate layer of material sandwiched between the container's outer surface and tabs 14. Further, the identification layer 15 may include printed material thereon or remain without printed material. For example, FIG. 2 shows the tab 14 removed to reveal a shape of a baseball on the identification layer 15.

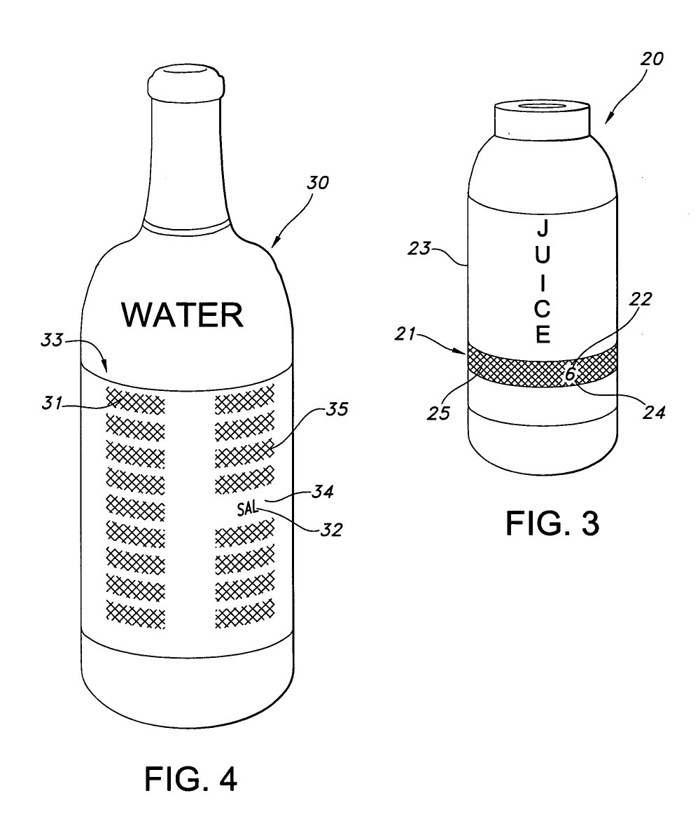

FIGS. 3 and 4 show an alternative embodiment of coding and personalizing containers. The identification mechanisms 25 and 33 of FIGS. 3 and 4, respectively, are similar to the identification mechanisms of FIGS. 1 and 2 including an opaque layer and identification layer. The opaque layer 21 and 31 of FIGS. 3 and 4, respectively, is formed from a scratch-off material. The removal of the opaque layer 21 and 31 reveals a portion of the identification layer 24 and 34, respectively. The opaque layer 21 and 31 may include printed material or remain without printing thereon. Similarly, the identification layer 24 and 34 may include printed material thereon or remain without printed material. Either the identification layer 24 and 34 as defined herein refers to the outer surface of the container or a separate layer of material sandwiched between the container's outer surface and opaque layer 21 and 31, respectively.

FIG. 3 shows a beverage container 20 having an identification mechanism 25 on the label 23. The identification mechanism 25 includes an opaque layer 21 and an identification layer 24. The identification layer 24 has numbers 22 printed thereon. The opaque layer covers the identification layer 24 and number 22. Upon removal of any part of the opaque layer 21, one or more of the numbers 22 of the identification layer 24 are shown.

Similarly, the container 30 of FIG. 4 shows an identification mechanism 33 of the present invention including an opaque layer 31 and an identification layer 34. The opaque layer has names 35 printed thereon. The opaque layer 31 is removably attached to the identification layer 34 and the opaque layer 31 covers the identification layer 34. The identification layer 34 includes corresponding printed material 32 thereon. Upon removal of the opaque layer 31, one or more of the printed material 32 of the identification layer 34 may be revealed.

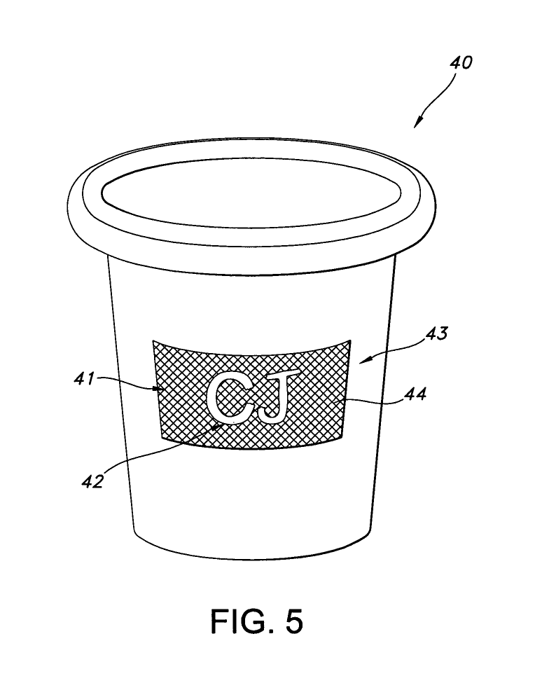

A further embodiment, as shown in FIG. 5, is identification mechanism 44. The identification mechanism 44 is shown on container 40. The identification mechanism 44 includes an opaque scratch off portion 41 applied over the container's outer surface 43. The opaque scratch off portion 41 allows one to scratch out any design, symbol, name, initials or marking therein to provide customized identification thereon. FIG. 5 shows the initials 42 “CJ” scratched out of the opaque scratch off portion 41 and revealing the underlying container's surface. While the opaque scratch off portion 41 shown in FIG. 5 covers the outer surface 43 of the container 40, it is contemplated that the opaque scratch off portion 41 can be applied over a variety of surfaces, such as a label, a cap, an identification layer (as above-described), etc. Further, the surface 43 may further include additional colors, shapes, patterns under the scratch off portion 41 to provide contrast upon removal thereof. Upon removal of the opaque scratch off portion 41, i.e. etching one's name, symbol, marking, code, etc., the surface 43 is revealed showing the color, shape, pattern, etc. thereunder.

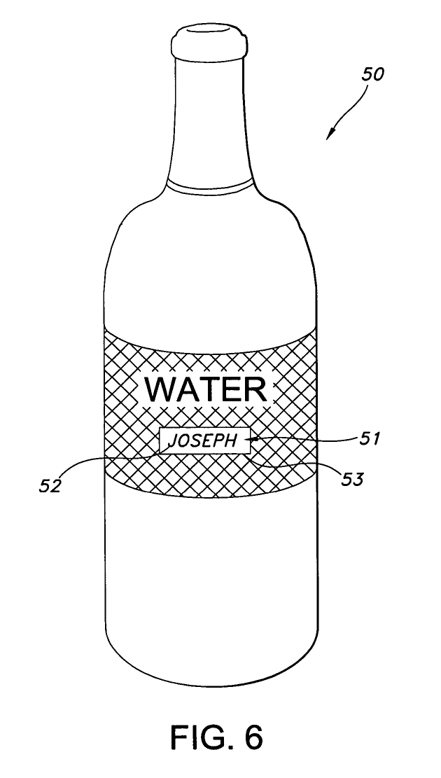

An alternative conceptualization for coding and personalizing a beverage container is shown in FIG. 6. FIG. 6 shows a container 50 including an identification mechanism 53 as a designated blank area 51 to write a customized identification 52 thereon. FIG. 6 shows printed name 52, “Joseph”, printed on the blank area 51. This surface would be designated for this function and constructed of a material that accepts and retains the markings of a pencil, pen, felt marker and/or indentation and concentrated pressure.

The present invention contemplates a method and apparatus to code and identify a beverage container, bottle, and can. The current designs call for beverage containers to display letters, numbers, names, symbols, shapes, patterns and/or colors that allow for personal coding and identification by each user. Using a scratch-off surface, adhesive covering, perforated covering, or designated blank area that retains the marking of pen, pencil, felt marker or indentation, each user can permanently code beverage containers. This beverage container coding system(s) will allow the consumer to avoid drinking from another's container and risk the transfer of germs.

What is claimed is:

1. An identification mechanism for a container comprising:
a container including distinct indicia thereon; and
individual covers over each of said distinct indicia, at least one of said cover is selectively removable to reveal at least one of said indicia thereunder to provide visual personalization of said container.

2. The identification mechanism of claim 1, said individual covers are perforated tabs.

3. The identification mechanism of claim 1, said individual covers are scratch off tabs.

4. The identification mechanism of claim 1, said individual covers are adhesive tabs.

5. The identification mechanism of claim 1, wherein said container includes an outer surface with said distinct indicia thereon, and an opaque layer being attached to said outer surface of said container, said opaque layer includes said individual covers therein.

6. The identification mechanism of claim 5, wherein said individual covers are perforated tabs within said opaque layer.

7. The identification mechanism of claim 6, wherein said tabs include printed material thereon.

8. The identification mechanism of claim 5, wherein said individual covers are adhesively removable tabs of said opaque layer.

9. The identification mechanism of claim 5, wherein said individual covers are scratch-off portions of said opaque layer.

10. The identification mechanism of claim 5, wherein said individual covers include printed material thereon.

11. An identification mechanism comprising:
a preprinted label having individual indicia printed thereon and perforated tabs therein, each of said perforated tabs correspond to a specific individual indicia, individually selected perforated tabs corresponding to said specific indicia are removable from said pre-printed label to provide a customization of said label.

12. A method for identifying a container comprising the steps of:
providing a container having an outer surface;
providing an opaque layer having a tab defined as a perforated portion;
attaching said opaque layer to said outersurface; and
removing select tabs to expose a portion of said outer surface thereunder to personalize said container.

13. The method for identifying a container of claim 12, wherein said step of providing said opaque layer further includes printing material on said opaque layer.

14. The method for identifying a container of claim 12, wherein said step of providing said container further includes printing material on said outer surface.

15. The method for identifying a container of claim 14, wherein said step of providing said opaque layer further includes printing material on said opaque layer.
